(19) United States
(12) Patent Application Publication
(10) Pub. No.: US 2013/0039535 A1
(43) Pub. Date: Feb. 14, 2013

(54) METHOD AND APPARATUS FOR REDUCING COMPLEXITY OF A COMPUTER VISION SYSTEM AND APPLYING RELATED COMPUTER VISION APPLICATIONS

(71) Applicants: Cheng-Tsai Ho, Taichung City (TW); Ding-Yun Chen, Taipei City (TW); Chi-Cheng Ju, Hsinchu City (TW)

(72) Inventors: Cheng-Tsai Ho, Taichung City (TW); Ding-Yun Chen, Taipei City (TW); Chi-Cheng Ju, Hsinchu City (TW)

(21) Appl. No.: 13/431,900

(22) Filed: Mar. 27, 2012

Related U.S. Application Data
(60) Provisional application No. 61/515,984, filed on Aug. 8, 2011.

(51) Int. Cl. G06K 9/62

(52) U.S. Cl. 382/103

(57) ABSTRACT

A method for reducing complexity of a computer vision system and applying related computer vision applications includes: obtaining instruction information, wherein the instruction information is used for a computer vision application; obtaining image data from a camera module and defining at least one region of recognition corresponding to the image data by user gesture input on a touch-sensitive display; outputting a recognition result of the aforementioned at least one region of recognition; and searching at least one database according to the recognition result. Associated apparatus are also provided. For example, the apparatus includes an instruction information generator, a processing circuit, and a database management module, where the instruction information generator obtains the instruction information, and the processing circuit obtains the image data from the camera module, defines the aforementioned at least one region of recognition and outputs a recognition result of the at least one region of recognition.

### CROSS REFERENCE TO RELATED APPLICATIONS

This application claims the benefit of U.S. Provisional Application No. 61/515,984, which was filed on Aug. 8, 2011 and is entitled “COMPUTER VISION LINK CLOUD LOOKING UP”, and is included herein by reference.

### BACKGROUND

The present invention relates to a computer vision system implemented with a portable electronic device, and more particularly, to a method and apparatus for reducing complexity of a computer vision system and applying related computer vision applications.

According to the related art, a portable electronic device equipped with a touch screen (e.g., a multifunctional mobile phone, a personal digital assistant (PDA), a tablet, etc) can be utilized for displaying a document or a message to be read by an end user. In a situation where the end user needs some information and tries to request the information by virtually typing some virtual keys/buttons on the touch screen, some problems may occur. For example, the end user typically has to use one hand to hold the portable electronic device and use the other hand to control the portable electronic device in the above situation, causing inconvenience since the end user may need to do something else with the other hand. In another example, the end user may be forced to waste time since it is not easy to complete the operation of virtually typing some virtual keys/buttons on the touch screen in a short period. In another example, suppose that the end user is not familiar with a foreign language. When the end user goes into a restaurant and wants to order something to eat, the end user may find that he/she does not understand the words on a menu since the words are written (or printed) in the foreign language mentioned above. It seems unlikely that the end user is capable of inputting some of the words on the menu into the portable electronic device since he/she is not familiar with the foreign language under consideration. Please note that a personal computer having a high calculation speed (rather than the portable electronic device) may be required for recognizing and translating all of the words on the menu since the associated operations are too complicated for the portable electronic device. In addition, forcibly utilizing the portable electronic device to perform the associated operations may lead to a low recognition rate, where recognition errors typically cause translation errors. In conclusion, the related art does not serve the end user well. Thus, a novel method is required for enhancing information access control of a portable electronic device.

### SUMMARY

It is therefore an objective of the claimed invention to provide a method and apparatus for reducing complexity of a computer vision system and applying related computer vision applications, and to provide an associated apparatus for reducing complexity of a portable electronic device and apply related computer vision applications, in order to solve the above-mentioned problems.

An exemplary embodiment of a method for reducing complexity of a computer vision system and applying related computer vision applications comprises the steps of: obtaining instruction information, wherein the instruction information is used for a computer vision application; obtaining image data from a camera module and defining at least one region of recognition corresponding to the image data by user gesture input on a touch-sensitive display; outputting a recognition result of the at least one region of recognition; and searching at least one database according to the recognition result. In particular, the step of searching the at least one database according to the recognition result further comprises: managing local or Internet database access to perform the computer vision application. More particularly, the step of managing the local or Internet database access further comprises: in a situation where it is automatically determined to utilize a server on Internet to perform the computer vision application, temporarily storing a computer vision application result into a local database, for further use of computer vision applications.

An exemplary embodiment of an apparatus for reducing complexity of a computer vision system and applying related computer vision applications is provided, wherein the apparatus comprises at least one portion of the computer vision system. The apparatus comprises an instruction information generator, a processing circuit, and a database management module. The instruction information generator is arranged to obtain instruction information, wherein the instruction information is used for a computer vision application. In addition, the processing circuit is arranged to obtain image data from a camera module and to define at least one region of recognition corresponding to the image data by user gesture input on a touch-sensitive display, wherein the processing circuit is further arranged to output a recognition result of the at least one region of recognition. Additionally, the database management module is arranged to search at least one database according to the recognition result. In particular, the database management module manages local or Internet database access to perform the computer vision application. More particularly, in a situation where the database management module automatically determines to utilize a server on Internet to perform the computer vision application, the database management module temporarily stores a computer vision application result into a local database, for further use of computer vision applications.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for reducing complexity of a computer vision system and applying related computer vision applications according to a first embodiment of the present invention.

FIG. 2 illustrates a flowchart of a method for reducing complexity of a computer vision system and applying related computer vision applications according to an embodiment of the present invention.

FIG. 3 illustrates the apparatus shown in FIG. 1 and some exemplary regions of recognition involved with the method shown in FIG. 2 according to an embodiment of the present invention, where the apparatus of this embodiment is a mobile phone.

FIG. 4 illustrates some exemplary regions of recognition involved with the method shown in FIG. 2 according to an embodiment of the present invention, where the regions of recognition in this embodiment comprises some portions of a menu image displayed on the touch screen shown in FIG. 3.

FIG. 5 illustrates an exemplary region of recognition involved with the method shown in FIG. 2 according to another embodiment of the present invention, where the region of recognition in this embodiment comprises an object displayed on the touch screen shown in FIG. 3.

FIG. 6 illustrates an exemplary region of recognition involved with the method shown in FIG. 2 according to another embodiment of the present invention, where the region of recognition in this embodiment comprises a human face image displayed on the touch screen shown in FIG. 3.

FIG. 7 illustrates an exemplary region of recognition involved with the method shown in FIG. 2 according to an embodiment of the present invention, where the region of recognition in this embodiment comprises a portion of a label image displayed on the touch screen shown in FIG. 3.

FIG. 8 illustrates an exemplary region of recognition involved with the method shown in FIG. 2 according to another embodiment of the present invention, where the region of recognition in this embodiment comprises a portion of a label image displayed on the touch screen shown in FIG. 3.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

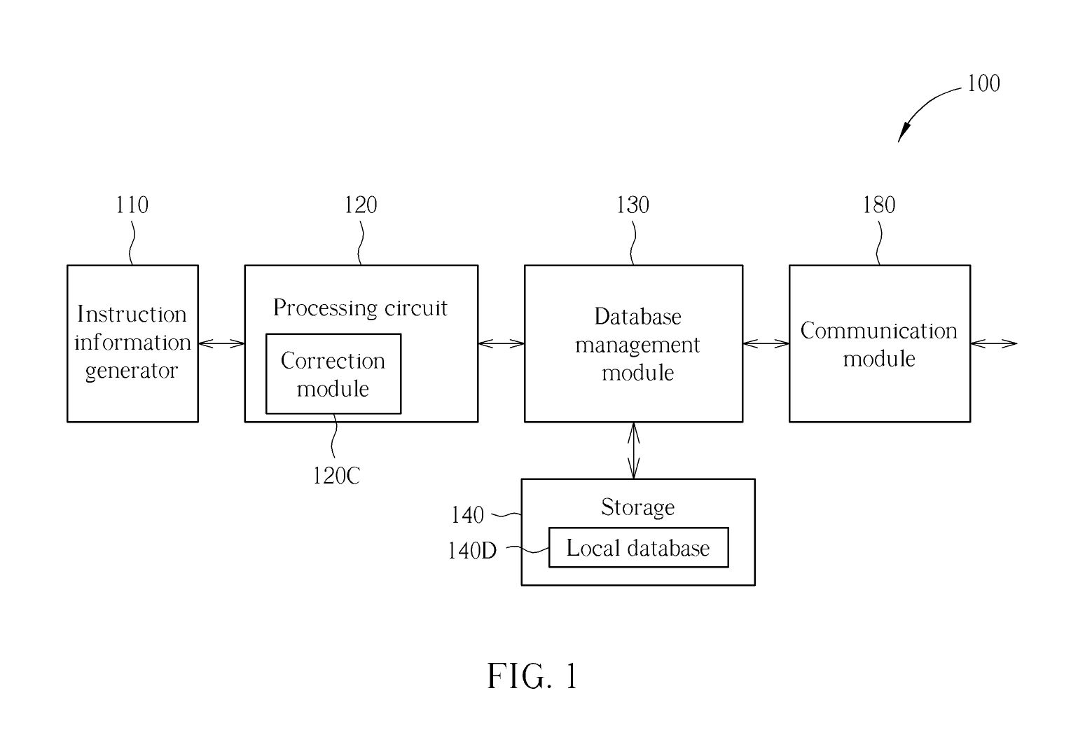

Please refer to FIG. 1, which illustrates a diagram of an apparatus 100 for reducing complexity of a computer vision system and applying related computer vision applications according to a first embodiment of the present invention, where the apparatus 100 comprises at least one portion (e.g. a portion or all) of the computer vision system. As shown in FIG. 1, the apparatus 100 comprises an instruction information generator 110, a processing circuit 120, a database management module 130, a storage 140, and a communication module 180, where the processing circuit 120 comprises a correction module 120C, and the storage 140 comprises a local database 140D. According to different embodiments, such as the first embodiment and some variations thereof, the apparatus 100 may comprise at least one portion (e.g. a portion or all) of an electronic device such as a portable electronic device, where the aforementioned computer vision system can be the whole of the electronic device such as the portable electronic device. For example, the apparatus 100 may comprise a portion of the electronic device mentioned above, and more particularly, can be a control circuit such as an integrated circuit (IC) within the electronic device. In another example, the apparatus 100 can be the whole of the electronic device mentioned above. In another example, the apparatus 100 can be an audio/video system comprising the electronic device mentioned above. Examples of the electronic device may include, but not limited to, a mobile phone (e.g. a multifunctional mobile phone), a personal digital assistant (PDA), a portable electronic device such as the so-called tablet (based on a generalized definition), and a personal computer such as a tablet personal computer (which can also be referred to as the tablet, for simplicity), a laptop computer, or desktop computer.

According to this embodiment, the instruction information generator 110 is arranged to obtain instruction information, where the instruction information is utilized for a computer vision application. In addition, the processing circuit 120 is utilized for controlling operations of the electronic device such as the portable electronic device. More particularly, the processing circuit 120 is arranged to obtain image data from a camera module (not shown) and to define at least one region of recognition (e.g. one or more regions of recognition) corresponding to the image data by user gesture input on a touch-sensitive display such as a touch screen (not shown in FIG. 1). The processing circuit 120 is further arranged to output a recognition result of the aforementioned at least one region of recognition. Additionally, the correction module 120C is arranged to selectively perform correction of the recognition result by providing user interface allowing a user to alter the recognition result by additional user gesture input on the touch-sensitive display such as the touch screen.

In this embodiment, the database management module 130 is arranged to search at least one database according to the recognition result. More particularly, the database management module 130 can manage local or Internet database access to perform the computer vision application. For example, in a situation where the database management module 130 automatically determines to utilize a server on Internet (e.g. a cloud server) to perform the computer vision application, the database management module 130 temporarily stores a computer vision application result into a local database, for further use of computer vision applications, where the storage 140 of this embodiment is arranged to temporarily store information, and the local database 140D therein can be taken as an example of the local database mentioned above. In practice, the storage 140 can be a memory (e.g. a volatile memory such as a random access memory (RAM), or a non-volatile memory such as a Flash memory), or can be a hard disk drive (HDD). In addition, according to power management information of the computer vision system, the database management module 130 can automatically determine whether to utilize the local database 140D or the aforementioned server on the Internet (e.g. the cloud server) to perform the computer vision application. Additionally, the communication module 180 is utilized for performing communication to send or receive information through the Internet. Based upon the architecture shown in FIG. 1, the database management module 130 is capable of selectively obtaining one or more looking-up results from the aforementioned server on the Internet (e.g. the cloud server) or from the local data base 140D to complete the computer vision application corresponding to the instruction information obtained from instruction information generator 110.

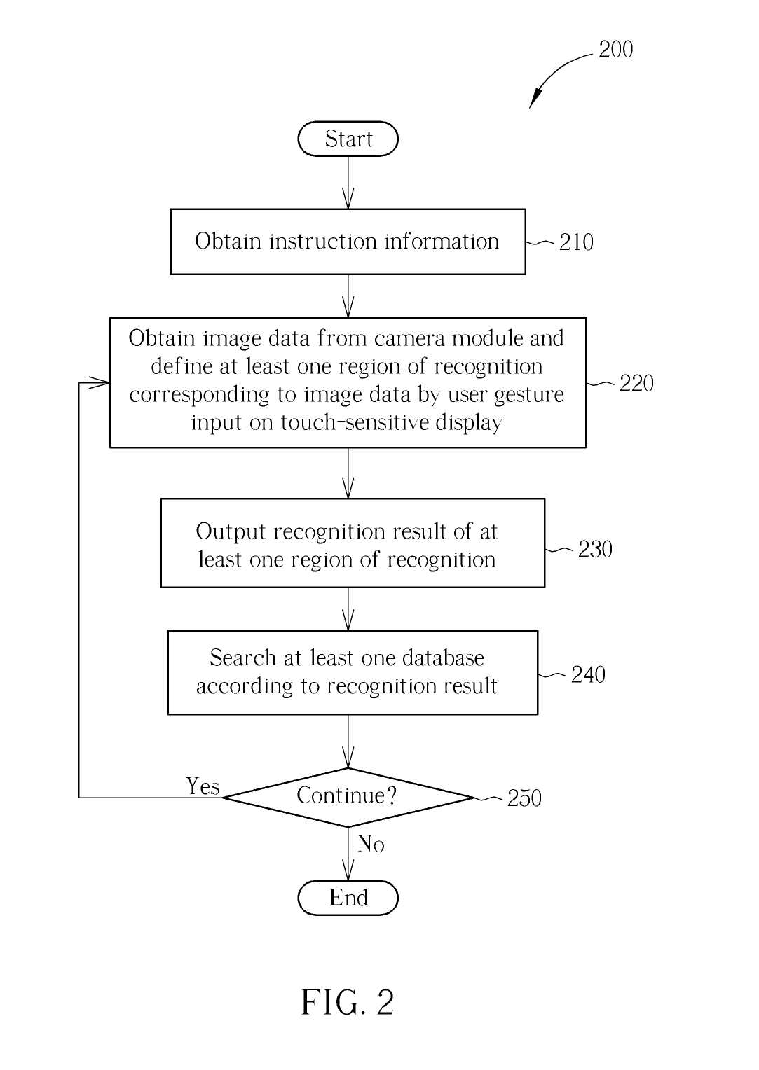

FIG. 2 illustrates a flowchart of a method 200 for reducing complexity of a computer vision system and applying related computer vision applications according to an embodiment of the present invention. The method 200 shown in FIG. 2 can be applied to the apparatus 100 shown in FIG. 1. The method is described as follows.

In Step 210, the instruction information generator 110 obtains instruction information such as that mentioned above, where the instruction information is utilized for a computer vision application. For example, the instruction information generator 110 may comprise a global navigation satellite system (GNSS) receiver such as a global positioning system (GPS) receiver, and at least one portion of the instruction information is obtained from the GNSS receiver, where the instruction information may comprise location information of the apparatus 100. In another example, the instruction information generator 110 may comprise an audio input module, and at least one portion (e.g. a portion or all) of the instruction information is obtained from the audio input module, where the instruction information may comprise an audio instruction that the apparatus 100 received from the user through the audio input module. In another example, the instruction information generator 110 may comprise the aforementioned touch-sensitive display such as the touch screen mentioned above, and at least one portion (e.g. a portion or all) of the instruction information is obtained from the touch screen, where the instruction information may comprise an instruction that the apparatus 100 received from the user through the touch screen.

Regarding the type of the computer vision application (e.g. a specific type of looking-up), it may vary based upon different applications, where the type of the computer vision application may be determined by the user or automatically determined by the apparatus 100 (more particularly, the processing circuit 120). For example, the computer vision application can be translation. In another example, the computer vision application can be exchange rate conversion (more specifically, the exchange rate conversion for different currencies). In another example, the computer vision application can be best price search (more particularly, the best price search for finding the best price of the same product). In another example, the computer vision application can be information search. In another example, the computer vision application can be map browsing. In another example, the computer vision application can be video trailer search.

In Step 220, the processing circuit 120 obtains image data such as that mentioned above from the camera module and defines at least one region of recognition (e.g. one or more regions of recognition) corresponding to the image data by user gesture input on the aforementioned touch-sensitive display such as the touch screen. For example, the user can touch the touch-sensitive display such as the touch screen one or more times, and more particularly, touch one or more portions of an image displayed on the touch-sensitive display such as the touch screen, in order to define the aforementioned at least one region of recognition (e.g. one or more regions of recognition) as the one or more portions of this image. Thus, the aforementioned at least one region of recognition (e.g. one or more regions of recognition) can be arbitrarily determined by the user.

Regarding the recognition involved with the aforementioned at least one region of recognition (more particularly, the recognition that the processing circuit 120 performs), it may vary based upon different applications, where the type of recognition may be determined by the user or automatically determined by the apparatus 100 (more particularly, the processing circuit 120). For example, the processing circuit 120 can perform text recognition on the region of recognition corresponding to the image data to generate the recognition result, where the recognition result is a text recognition result of a text on a target. In another example, the processing circuit 120 can perform object recognition on the region of recognition corresponding to the image data to generate the recognition result, where the recognition result is a text string representing an object. This is for illustrative purposes only, and is not meant to be a limitation of the present invention. According to some variations of this embodiment, in general, the recognition result may comprise at least one string, at least one character, and/or at least one number.

In Step 230, the processing circuit 120 outputs the recognition result of the at least one region of recognition to the aforementioned touch-sensitive display such as the touch screen. Thus, the user can determine whether the recognition result is correct or not and can selectively alter the recognition result by additional user gesture input on the touch-sensitive display such as the touch screen. For example, in a situation where the user confirms the recognition result, the correction module 120C utilizes the confirmed recognition result as the representative information of the region of recognition. In another example, in a situation where the user write a text string representing the object in the region of recognition directly, the correction module 120C performs re-recognition to obtain the altered recognition result and utilizes the altered recognition result as the representative information of the region of recognition.

In Step 240, the database management module 130 searches at least one database such as that mentioned above according to the recognition result. More particularly, the database management module 130 can manage local or Internet database access to perform the computer vision application. Based upon the architecture shown in FIG. 1, the database management module 130 selectively obtains one or more looking-up results from the aforementioned server on the Internet (e.g. the cloud server) or from the local data base 140D. In practice, the database management module 130 can obtain the one or more looking-up results from the aforementioned server on the Internet (e.g. the cloud server) by default, and in a situation where the access to the Internet is unavailable, the database management module 130 try to obtain the one or more looking-up results from the local data base 140D.

In Step 250, the processing circuit 120 determines whether to continue. For example, the processing circuit 120 can determine to continue by default, and in a situation where the user touches an icon representing stop, the processing circuit 120 determines to stop repeating operations of the loop formed with Step 220, Step 230, Step 240, and Step 250. When it is determined to continue, Step 220 is re-entered; otherwise, the working flow shown in FIG. 2 comes to the end.

According to this embodiment, the processing circuit 120 can provide user interface allowing the user to alter the recognition result by additional user gesture input on the aforementioned touch-sensitive display such as the touch screen. And the processing circuit 120 can perform a learning operation by storing correction information corresponding to mapping relationship between the recognition result and the altered recognition result, for further use of automatic correction of recognition results. More particularly, the correction information can be utilized for mapping the recognition result into the altered recognition result, and the correction module 120C can utilize the correction information to perform automatic correction of recognition results. This is for illustrative purposes only, and is not meant to be a limitation of the present invention. According to some variations of this embodiment, the processing circuit 120 provides the user interface allowing the user to write text under recognition directly by the additional user gesture input on the touch-sensitive display such as the touch screen, and performs text recognition. According to some variations of this embodiment, the processing circuit 120 provides the user interface allowing the user to write a text string representing an object under recognition directly by the additional user gesture input on the touch-sensitive display such as the touch screen, and performs text recognition.

As mentioned, the database management module 130 can obtain the one or more looking-up results from the aforementioned server on the Internet (e.g. the cloud server) by default, and in a situation where the access to the Internet is unavailable, the database management module 130 try to obtain the one or more looking-up results from the local data base 140D. This is for illustrative purposes only, and is not meant to be a limitation of the present invention. According to some variations of this embodiment, the database management module 130 can automatically determine whether to utilize the local database 140D or the server on the Internet (e.g. the cloud server), to perform the computer vision application. More particularly, according to power management information of the computer vision system (e.g. the electronic device such as the portable electronic device in this embodiment), the database management module 130 automatically determines whether to utilize the local database 140D or the server on the Internet (e.g. the cloud server) for performing the looking-up. In practice, in a situation where the database management module 130 automatically determines to utilize the server on the Internet (e.g. the cloud server) for performing the looking-up, the database management module 130 obtains the looking-up result from the server on the Internet (e.g. the cloud server) and then temporarily stores the looking-up result into the local database 140D, for further use of looking-up. Similar descriptions are not repeated in detail for these variations.

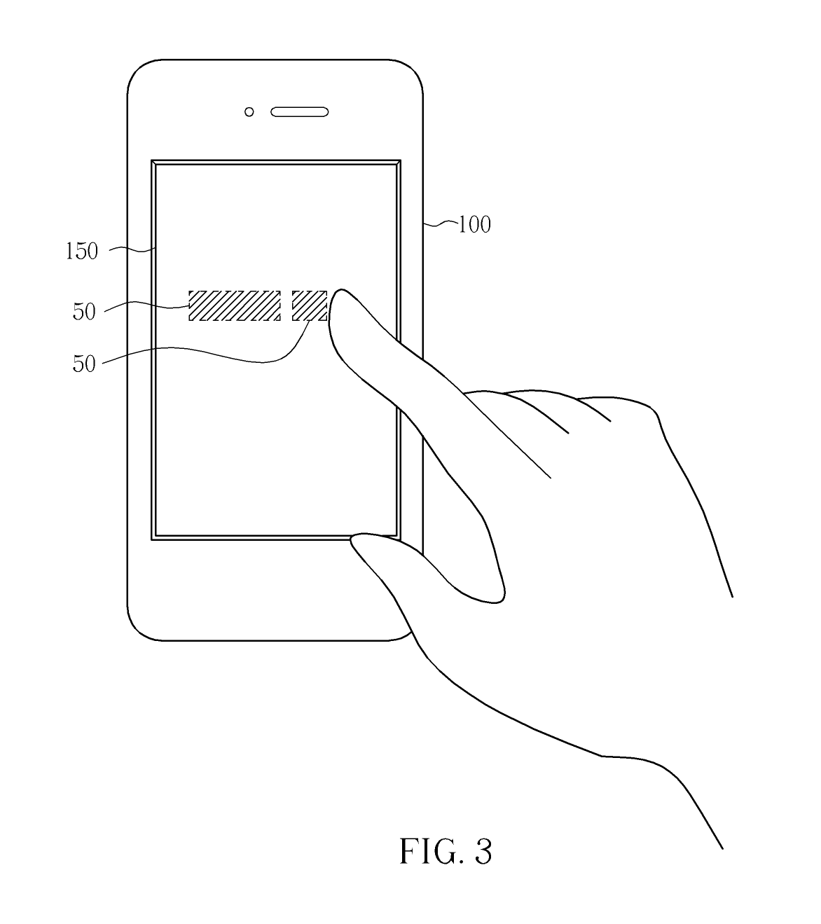

FIG. 3 illustrates the apparatus 100 shown in FIG. 1 and some exemplary regions of recognition 50 involved with the method 200 shown in FIG. 2 according to an embodiment of the present invention, where the apparatus 100 of this embodiment is a mobile phone, and more particularly, a multifunctional mobile phone. According to this embodiment, a camera module (not shown) of the apparatus 100 is positioned around the back of the apparatus 100. In addition, a touch screen 150 is taken as an example of the touch screen mentioned in the first embodiment, where the touch screen 150 of this embodiment is installed within the apparatus 100 and can be utilized for displaying a plurality of preview images or captured images. In practice, the camera module can be utilized for performing a preview operation to generate the image data of the preview images, for being displayed on the touch screen 150, or can be utilized for performing a capturing operation to generate the image data of one of the captured images.

With the aid of the operations of the method 200, when the user defines (more particularly, uses his/her finger to slide on) one or more regions on the image displayed on the touch screen 150 shown in FIG. 3, such as the regions of recognition 50 in this embodiment, the processing circuit 120 can instantly output the looking-up result to the touch screen 150, for displaying the looking-up result. As a result, the user can understand the target under consideration instantly, having no need to virtually type some virtual keys/buttons on the touch screen 150. Similar descriptions are not repeated in detail for this embodiment.

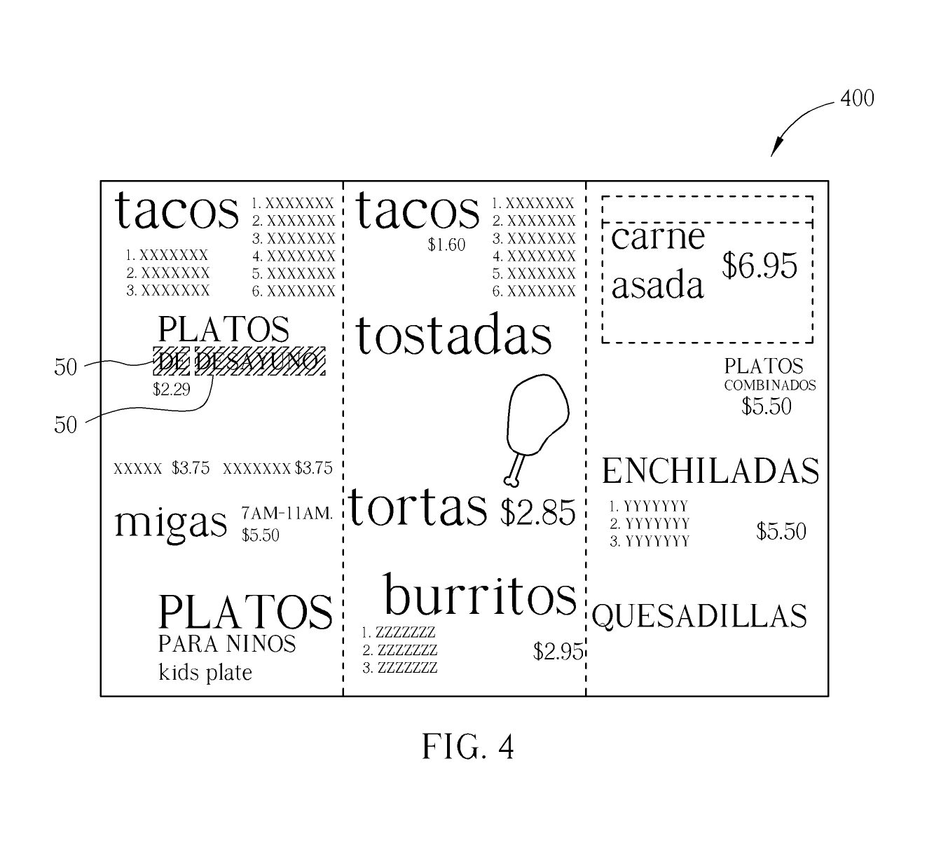

FIG. 4 illustrates some exemplary regions of recognition 50 involved with the method 200 shown in FIG. 2 according to an embodiment of the present invention, where the regions of recognition 50 in this embodiment comprises some portions of a menu image 400 displayed on the touch screen 150 shown in FIG. 3. Based upon the user gesture input mentioned in Step 220, the processing circuit 120 defines the aforementioned at least one region of recognition, such as the regions of recognition 50 within the menu image 400 shown in FIG. 4, to make pauses for a text recognition operation, where the menu represented by the menu image 400 comprises some texts of a specific language.

Suppose that the user is not familiar with the specific language, where the computer vision application in this embodiment can be translation. With the aid of the operations of the method 200, when the user defines (more particularly, uses his/her finger to slide on) the regions of recognition 50 on the menu image 400 shown in FIG. 4, the processing circuit 120 can instantly output the looking-up result (e.g. the translation of the words are within the regions of recognition 50, respectively) to the touch screen 150, for displaying the looking-up result. As a result, the user can understand the words under consideration instantly, having no need to virtually type some virtual keys/buttons on the touch screen 150. Similar descriptions are not repeated in detail for this embodiment.

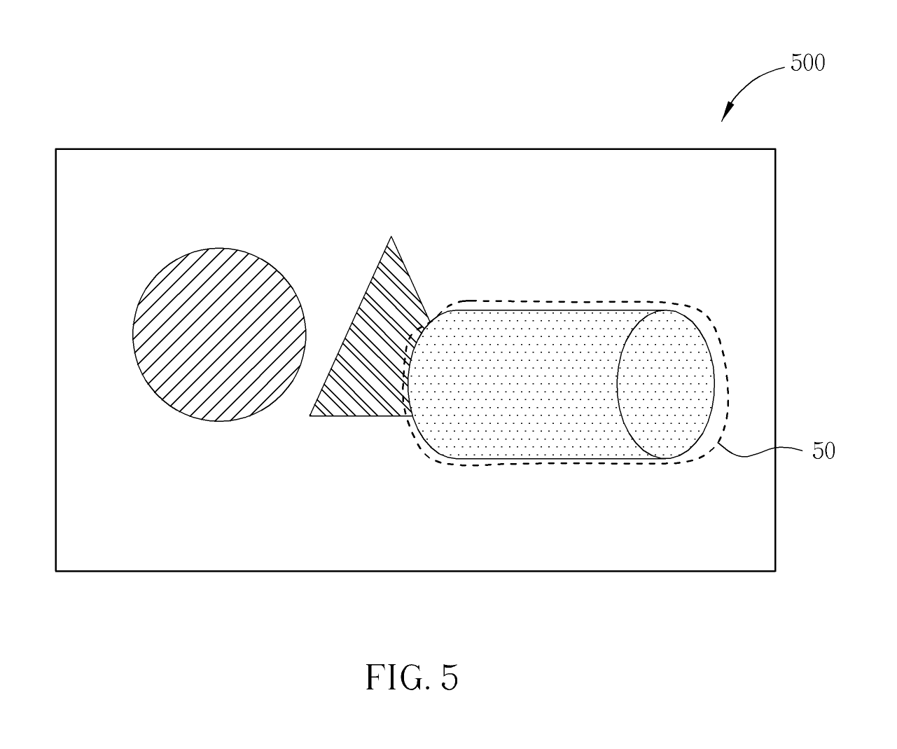

FIG. 5 illustrates an exemplary region of recognition 50 involved with the method 200 shown in FIG. 2 according to another embodiment of the present invention, where the region of recognition 50 in this embodiment comprises an object displayed on the touch screen 150 shown in FIG. 3. Based upon the user gesture input mentioned in Step 220, the processing circuit 120 defines the aforementioned at least one region of recognition, such as the region of recognition 50 within the object image 500 shown in FIG. 5, to determine object outline(s) for an object recognition operation. Thus, the processing circuit 120 can perform the object recognition operation on the object under consideration, such as the cylinder represented by the region of recognition 50 in this embodiment. For example, with the aid of the operations of the method 200, when the user defines (more particularly, uses his/her finger to slide on) the region of recognition 50 in this embodiment, the processing circuit 120 can instantly output the looking-up result to the touch screen 150, for displaying the looking-up result. As a result, the user can read the looking-up result such as the word, the phrase, or the sentence corresponding to the object under consideration (e.g. the word of a foreign language to the user, or the phrase or the sentence associated to the object) instantly. In another example, with the aid of the operations of the method 200, when the user defines (more particularly, uses his/her finger to slide on) the region of recognition 50 in this embodiment, the processing circuit 120 can instantly output the looking-up result to an audio output module, for playing back the looking-up result. As a result, the user can hear the looking-up result such as the word, the phrase, or the sentence corresponding to the object under consideration (e.g. the word of a foreign language to the user, or the phrase or the sentence associated to the object) instantly. Similar descriptions are not repeated in detail for this embodiment.

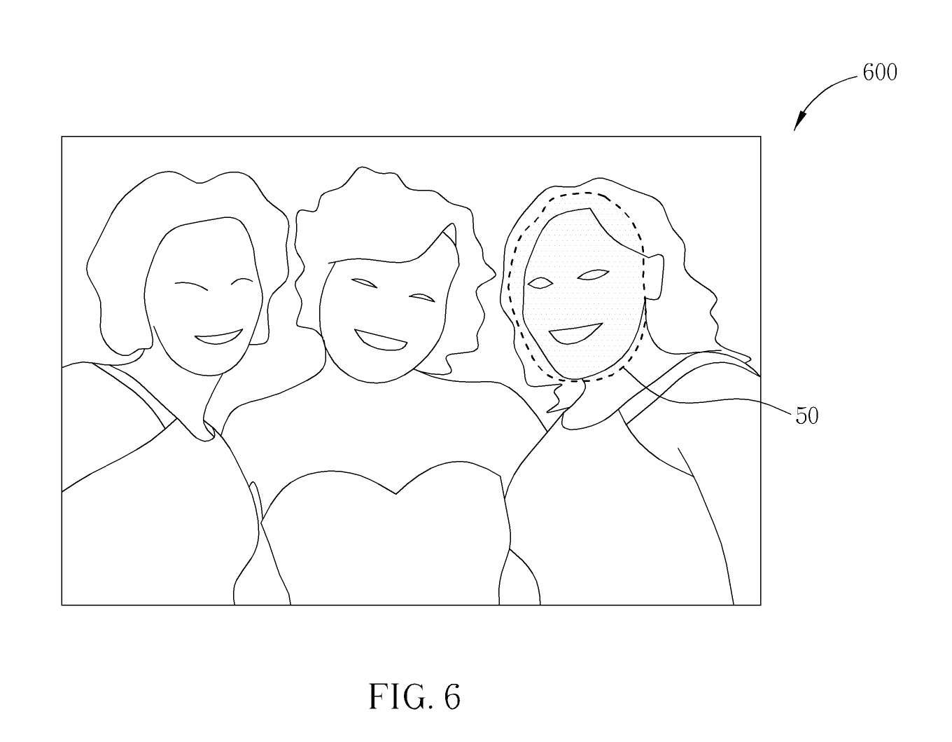

FIG. 6 illustrates an exemplary region of recognition 50 involved with the method 200 shown in FIG. 2 according to another embodiment of the present invention, where the region of recognition 50 in this embodiment comprises a human face image displayed on the touch screen 150 shown in FIG. 3. Based upon the user gesture input mentioned in Step 220, the processing circuit 120 defines the aforementioned at least one region of recognition, such as the region of recognition 50 within the photo image 600 shown in FIG. 6, to determine object outline(s) for an object recognition operation. Thus, the processing circuit 120 can perform the object recognition operation on the object under consideration, such as the human face represented by the region of recognition 50 in this embodiment. For example, with the aid of the operations of the method 200, when the user defines (more particularly, uses his/her finger to slide on) the region of recognition 50 in this embodiment, the processing circuit 120 can instantly output the looking-up result to the touch screen 150, for displaying the looking-up result. As a result, the user can read the looking-up result such as the word, the phrase, or the sentence corresponding to the human face under consideration (e.g. the name, the phone number, the favorite food, the favorite song, or the greetings of the person whose face image is within the region of recognition 50) instantly. In another example, with the aid of the operations of the method 200, when the user defines (more particularly, uses his/her finger to slide on) the region of recognition 50 in this embodiment, the processing circuit 120 can instantly output the looking-up result to an audio output module, for playing back the looking-up result. As a result, the user can hear the looking-up result such as the word, the phrase, or the sentence corresponding to the object under consideration (e.g. the name, the phone number, the favorite food, the favorite song, or the greetings of the person whose face image is within the region of recognition 50) instantly. Similar descriptions are not repeated in detail for this embodiment.

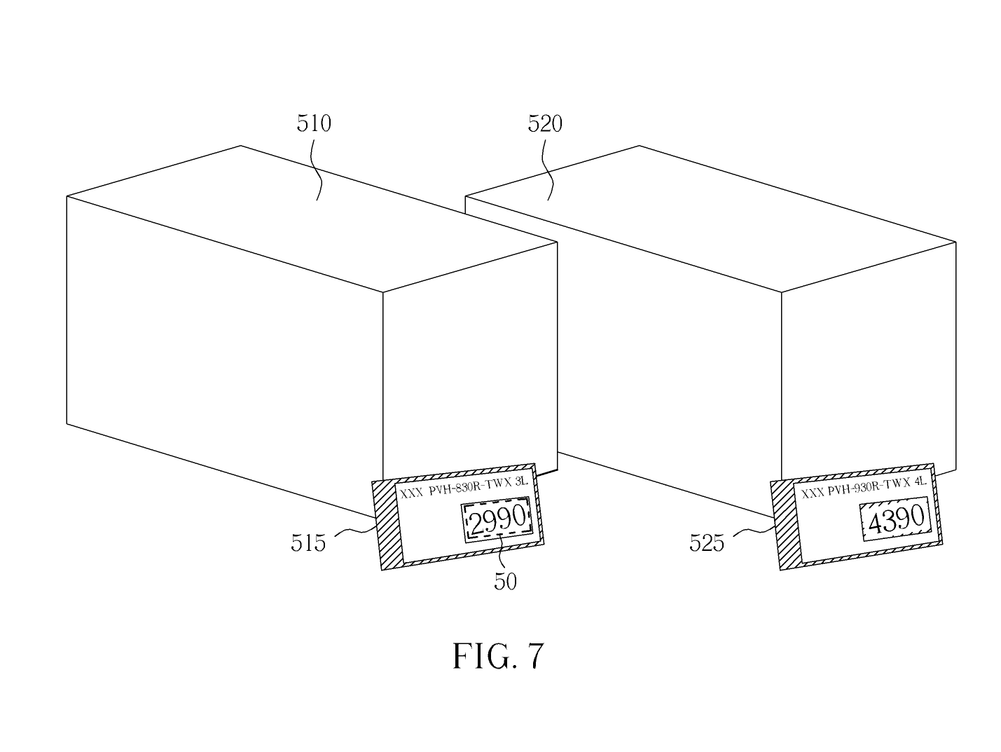

FIG. 7 illustrates an exemplary region of recognition 50 involved with the method 200 shown in FIG. 2 according to an embodiment of the present invention, where the region of recognition 50 in this embodiment comprises a portion of a label image displayed on the touch screen 150 shown in FIG. 3. In the image shown in FIG. 7, there are some products 510 and 520 and the associated labels 515 and 525. For example, the label under consideration in this embodiment can be the label 515, where the region of recognition 50 in this embodiment can be a partial image of the label 515.

Suppose that the user is not familiar with exchange rate conversion for different currencies and that the user is not sure of the price of the product 510 regarding the currency of his/her own country, where the computer vision application in this embodiment can be exchange rate conversion for different currencies. With the aid of the operations of the method 200, when the user defines (more particularly, uses his/her finger to slide on) the region of recognition 50 in this embodiment, the processing circuit 120 instantly outputs the looking-up result to the touch screen 150, for displaying the looking-up result. According to this embodiment, the looking-up result can be the exchange rate conversion result of the price is within the region of recognition 50. More particularly, the looking-up result can be the price regarding the currency of the country of the user. As a result, the user can instantly realize how much the product 510 costs regarding the currency of his/her own country, having no need to virtually type some virtual keys/buttons on the touch screen 150. Similar descriptions are not repeated in detail for this embodiment.

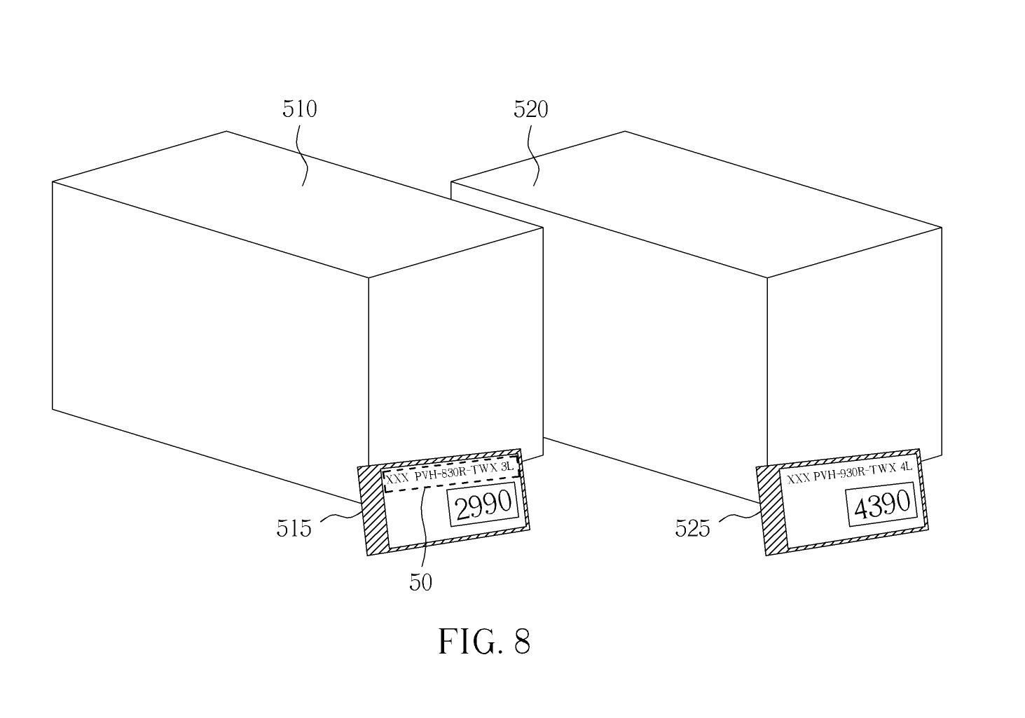

FIG. 8 illustrates an exemplary region of recognition 50 involved with the method 200 shown in FIG. 2 according to another embodiment of the present invention, where the region of recognition 50 in this embodiment comprises a portion of a label image displayed on the touch screen 150 shown in FIG. 3. In the image shown in FIG. 8, there are some products such as the aforementioned products 510 and 520 and the associated labels 515 and 525. For example, the label under consideration in this embodiment can be the label 515, where the region of recognition 50 in this embodiment can be a partial image of the label 515.

Suppose that the user is not familiar with the prices of the same product 510 in different department stores, respectively, where the computer vision application in this embodiment can be best price search. With the aid of the operations of the method 200, when the user defines (more particularly, uses his/her finger to slide on) the region of recognition 50 in this embodiment, the processing circuit 120 instantly outputs the looking-up result to the touch screen 150, for displaying the looking-up result. According to this embodiment, the looking-up result can be the best price of the same product 510 in a specific store (e.g. the store where the user stays at that moment, or another store) and the associated information thereof (e.g. the name, the location, and/or the phone number(s) of the specific store), or can be the best prices of the same product 510 in a plurality of stores and the associated information thereof (e.g. the names, the locations, and/or the phone numbers of the plurality of stores). As a result, the user can instantly realize whether the price on the label 515 is the best price or not, having no need to virtually type some virtual keys/buttons on the touch screen 150. Similar descriptions are not repeated in detail for this embodiment.

It is an advantage of the present invention that the present invention method and apparatus allow the user to freely control the portable electronic device by determine the region of recognition on the image under consideration. As a result, the user can rapidly access required information without introducing any of the related art problems.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for reducing complexity of a computer vision system and applying related computer vision applications, the method comprising the steps of:
obtaining instruction information, wherein the instruction information is used for a computer vision application;
obtaining image data from a camera module and defining at least one region of recognition corresponding to the image data by user gesture input on a touch-sensitive display;
outputting a recognition result of the at least one region of recognition; and
searching at least one database according to the recognition result.

2. The method of claim 1, wherein at least one portion of the instruction information is obtained from a global navigation satellite system (GNSS) receiver.

3. The method of claim 1, wherein at least one portion of the instruction information is obtained from an audio input module.

4. The method of claim 1, wherein at least one portion of the instruction information is obtained from the touch-sensitive display.

5. The method of claim 1, wherein the computer vision application is translation.

6. The method of claim 1, wherein the computer vision application is exchange rate conversion.

7. The method of claim 1, wherein the computer vision application is best price search.

8. The method of claim 1, wherein the computer vision application is information search.

9. The method of claim 1, wherein the computer vision application is map browsing.

10. The method of claim 1, wherein the computer vision application is video trailer search.

11. The method of claim 1, further comprising:
performing text recognition on the region of recognition corresponding to the image data to generate the recognition result, wherein the recognition result is a text recognition result.

12. The method of claim 1, further comprising:
performing object recognition on the region of recognition corresponding to the image data to generate the recognition result, wherein the recognition result is a text string representing an object.

13. The method of claim 1, wherein defining the at least one region of recognition corresponding to the image data by the user gesture input on the touch-sensitive display further comprises:
defining the at least one region of recognition to make pauses for a text recognition operation.

14. The method of claim 1, wherein defining the at least one region of recognition corresponding to the image data by the user gesture input on the touch-sensitive display further comprises:
defining the at least one region of recognition to determine object outline(s) for an object recognition operation.

15. The method of claim 1, wherein outputting the recognition result of the at least one region of recognition further comprises:
providing user interface allowing a user to alter the recognition result by additional user gesture input on the touch-sensitive display.

16. The method of claim 15, wherein the step of providing the user interface allowing the user to alter the recognition result by the additional user gesture input on the touch-sensitive display further comprises:
providing the user interface allowing the user to write text under recognition directly by the additional user gesture input on the touch-sensitive display, and performing text recognition.

17. The method of claim 15, wherein the step of providing the user interface allowing the user to alter the recognition result by the additional user gesture input on the touch-sensitive display further comprises:
providing the user interface allowing the user to write a text string representing an object under recognition directly by the additional user gesture input on the touch-sensitive display, and performing text recognition.

18. The method of claim 15, wherein the step of providing the user interface allowing the user to alter the recognition result by the additional user gesture input on the touch-sensitive display further comprises:
performing a learning operation by storing correction information corresponding to mapping relationship between the recognition result and the altered recognition result, for further use of automatic correction of recognition results.

19. The method of claim 1, wherein the step of searching the at least one database according to the recognition result further comprises:
automatically determining whether to utilize a local database or a server on Internet, to perform the computer vision application.

20. The method of claim 1, wherein the step of searching the at least one database according to the recognition result further comprises:
managing local or Internet database access to perform the computer vision application.

21. The method of claim 20, wherein the step of managing the local or Internet database access further comprises:
in a situation where it is automatically determined to utilize a server on Internet to perform the computer vision application, temporarily storing a computer vision application result into a local database, for further use of computer vision applications.

22. The method of claim 20, wherein the step of managing the local or Internet database access further comprises:
according to power management information of the computer vision system, automatically determining whether to utilize a local database or a server on Internet to perform the computer vision application.

23. An apparatus for reducing complexity of a computer vision system and applying related computer vision applications, the apparatus comprising at least one portion of the computer vision system, the apparatus comprising:
an instruction information generator arranged to obtain instruction information, wherein the instruction information is used for a computer vision application;
a processing circuit arranged to obtain image data from a camera module and to define at least one region of recognition corresponding to the image data by user gesture input on a touch-sensitive display, wherein the processing circuit is further arranged to output a recognition result of the at least one region of recognition; and
a database management module arranged to search at least one database according to the recognition result.

24. The apparatus of claim 23, wherein the instruction information generator comprises a global navigation satellite system (GNSS) receiver; and at least one portion of the instruction information is obtained from the GNSS receiver.

25. The apparatus of claim 23, wherein the instruction information generator comprises an audio input module; and at least one portion of the instruction information is obtained from the audio input module.

26. The apparatus of claim 23, wherein the instruction information generator comprises the touch-sensitive display; and at least one portion of the instruction information is obtained from the touch-sensitive display.

27. The apparatus of claim 23, wherein the computer vision application is translation.

28. The apparatus of claim 23, wherein the computer vision application is exchange rate conversion.

29. The apparatus of claim 23, wherein the computer vision application is best price search.

30. The apparatus of claim 23, wherein the computer vision application is information search.

31. The apparatus of claim 23, wherein the computer vision application is map browsing.

32. The apparatus of claim 23, wherein the computer vision application is video trailer search.

33. The apparatus of claim 23, wherein the processing circuit performs text recognition on the region of recognition corresponding to the image data to generate the recognition result, wherein the recognition result is a text recognition result.

34. The apparatus of claim 23, wherein the processing circuit performs object recognition on the region of recognition corresponding to the image data to generate the recognition result, wherein the recognition result is a text string representing an object.

35. The apparatus of claim 23, wherein the processing circuit defines the at least one region of recognition to make pauses for a text recognition operation.

36. The apparatus of claim 23, wherein the processing circuit defines the at least one region of recognition to determine object outline(s) for an object recognition operation.

37. The apparatus of claim 23, wherein the processing circuit provides user interface allowing a user to alter the recognition result by additional user gesture input on the touch-sensitive display.

38. The apparatus of claim 37, wherein the processing circuit provides the user interface allowing the user to write text under recognition directly by the additional user gesture input on the touch-sensitive display, and performs text recognition.

39. The apparatus of claim 37, wherein the processing circuit provides the user interface allowing the user to write a text string representing an object under recognition directly by the additional user gesture input on the touch-sensitive display, and performs text recognition.

40. The apparatus of claim 37, wherein the processing circuit performs a learning operation by storing correction information corresponding to mapping relationship between the recognition result and the altered recognition result, for further use of automatic correction of recognition results.

41. The apparatus of claim 23, wherein the database management module automatically determines whether to utilize a local database or a server on Internet, to perform the computer vision application.

42. The apparatus of claim 23, wherein the database management module manages local or Internet database access to perform the computer vision application.

43. The apparatus of claim 42, wherein in a situation where the database management module automatically determines to utilize a server on Internet to perform the computer vision application, the database management module temporarily stores a computer vision application result into a local database, for further use of computer vision applications.

44. The apparatus of claim 42, wherein according to power management information of the computer vision system, the database management module automatically determines whether to utilize a local database or a server on Internet to perform the computer vision application.
